(19) United States
(12) Patent Application Publication
(10) Pub. No.: US 2020/0087958 A1
(43) Pub. Date: Mar. 19, 2020

(54) DRAW LATCH

(71) Applicant: Tietoset Oy, Helsinki (FI)

(72) Inventor: Antti SIISKONEN, Helsinki (Vantaa) (FI)

(73) Assignee: Tietoset Oy, Helsinki (FI)

(21) Appl. No.: 16/287,555

(22) Filed: Feb. 27, 2019

(30) Foreign Application Priority Data
Sep. 17, 2018 (EP) 18194786.2

(51) Int. Cl. E05C 19/14; E05B 67/38; E05B 13/10; B63B 19/00

(52) U.S. Cl. CPC E05C 19/14; E05B 67/383; B63B 2019/0069; B63B 19/00; E05Y 2900/514; E05B 13/10

(57) ABSTRACT

A draw latch (1) for latching together two closure members of a watercraft, which draw latch have an open position, wherein the two closure members are not latched, and a latched position, wherein the two closure members are secured, comprising a keeper (2) arranged to be attached to a first closure member, a base (3) arranged to be attached to a second closure member, a lever (4) pivotally connected to the base (3), a locking member (5), made of elastic material, pivotally connected to the lever (4), and arranged to be affixed to the keeper (2) when the draw latch is in the latched position. The draw latch further comprises a metal housing (6) arranged to cover the keeper, base, lever and elastic locking member against the two closure members when the keeper is attached to the first closure member, the base is attached to the second closure member and the draw latch is in the latched position.

### TECHNICAL FIELD

The present invention relates to a device for securing two closure members together.

### BACKGROUND OF THE ART

Known draw latches comprise generally a keeper and a one-piece part having three segments such as a base segment, a locking segment and an intermediate segment wherein the intermediate segment is connected to the base and locking segments. When in a latched condition, the locking segment is detachably connected to the keeper and is in overlaying relation to the keeper, the base segment and the intermediate segment. Typically latches are made of metal to achieve a needed durability against environmental conditions and protection against external forces. However, in use metal parts tends to wear and they may loosen in time. Thus, worn metal latches do not work properly and may even open by themselves.

In some applications, it is known to use rubber locking segments which, in a latched condition, are stretched over the keeper. However, the rubber tends to perish in time, especially when it is exposed to environmental conditions such as ultraviolet radiation and weather. Rubber draw latches are also easy to cut open and, thus, they are weak against burglary.

The draw latches are typically used in doors, windows and hatches. Depending on the intended use, different kinds of requirements are set for the draw latch. For example in watercrafts, the draw latches are exposed to extreme humidity and other weather conditions.

### OBJECTIVE OF THE INVENTION

The objective of the device/method is to alleviate the disadvantages mentioned above.

In particular, it is an objective of the present device which is durable and safe in all conditions.

### SUMMARY

According to a first aspect, the present invention provides a draw latch for latching together two closure members of a watercraft, which draw latch have an open position, wherein the two closure members are not latched, and a latched position, wherein the two closure members are secured. The drew latch comprises a keeper arranged to be attached to a first closure member, a base arranged to be attached to a second closure member, a lever pivotally connected to the base, a locking member, made of elastic material, pivotally connected to the lever, and arranged to be affixed to the keeper when the draw latch is in the latched position. The draw latch further comprises a metal housing arranged to cover the keeper, base, lever and elastic locking member against the two closure members when the keeper is attached to the first closure member, the base is attached to the second closure member and the draw latch is in the latched position.

In an embodiment of the device the locking member is connected to the lever by a pin, wherein the locking member is arranged to pivot around the longitudinal axis of the pin.

In an embodiment of the device the draw latch comprises a gap between a first end of the locking member, which is nearer to the keeper, and the corresponding end of the metal housing.

In an embodiment of the device the connection between the lever and the locking member is closer to the second closure member than the connection point between the lever and the base when the keeper is attached to the first closure member, the base is attached to the second closure member and the draw latch is in the latched position.

In an embodiment of the device the metal housing comprises at least one locking hole and the base comprises at least one opening, wherein the locking hole and the opening are arranged to be aligned when the draw latch is in latched position, and arranged to receive locking means, such as padlock, for locking the draw latch.

In an embodiment of the device the elastic material is rubber.

In an embodiment of the device the metal housing is made of aluminium.

In an embodiment of the device the metal housing is made of steel.

In an embodiment of the device the keeper is a flat sheet comprising a flat portion arranged to be attached to the first closure member, a middle portion, and a protrusion so that the middle portion is folded from the flat portion, and the protrusion is further folded from the middle portion so that the flat portion and the protrusion are essentially parallel, whereby the protrusion is arranged to detent the locking member when the draw latch is in latched position.

In an embodiment of the device the locking member comprises a transverse shaft arranged to overlap the keeper to detent the draw latch in latched position.

In an embodiment of the device the pin and the transverse shaft are arranged to run through the metal housing and the locking member, whereby the metal housing is connected to the locking member.

It is to be understood that the aspects and embodiments of the invention described above may be used in any combination with each other. Several of the aspects and embodiments may be combined together to form a further embodiment of the invention.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 shows a draw latch in a latched position,

FIG. 2 shows the draw latch in an open position,

FIG. 3 shows a cross section of a draw latch in a latched position,

FIG. 4 shows a cross section of a draw latch in an open position, and

FIG. 5 illustrates the base of the draw latch,

FIG. 6 illustrates the lever of the draw latch,

FIG. 7 illustrates the locking member of the draw latch,

FIG. 8 illustrates the keeper of the draw latch,

FIG. 9 illustrates the metal housing of the draw latch, and

FIG. 10 illustrates an embodiment of the metal housing of the draw latch.

### DETAILED DESCRIPTION

The draw latches are used for latching two closure members. The closure members are not shown in the figures as they are not part of the invention as such. However, the closure members are used in the description for understanding the invention better.

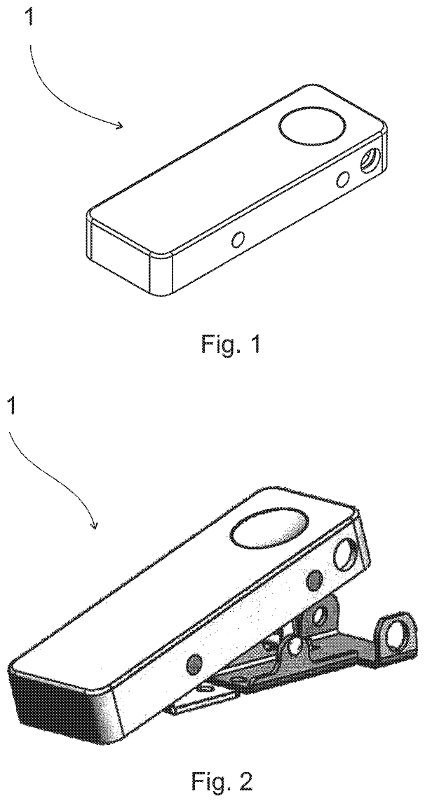

FIG. 1 shows a draw latch 1 in a latched position and FIG. 2 shows a draw latch 1 in an open position. As seen, the housing of the draw latch is the only visible part and no internal parts are shown when the draw latch is in latched position. As the internal parts are covered by the housing, they are not exposed to the external conditions such as rain, ultraviolet radiation (UV-radiation), and external forces such as impacts. When the draw latch is in the open position, some of the internal parts are exposed as seen in FIG. 2.

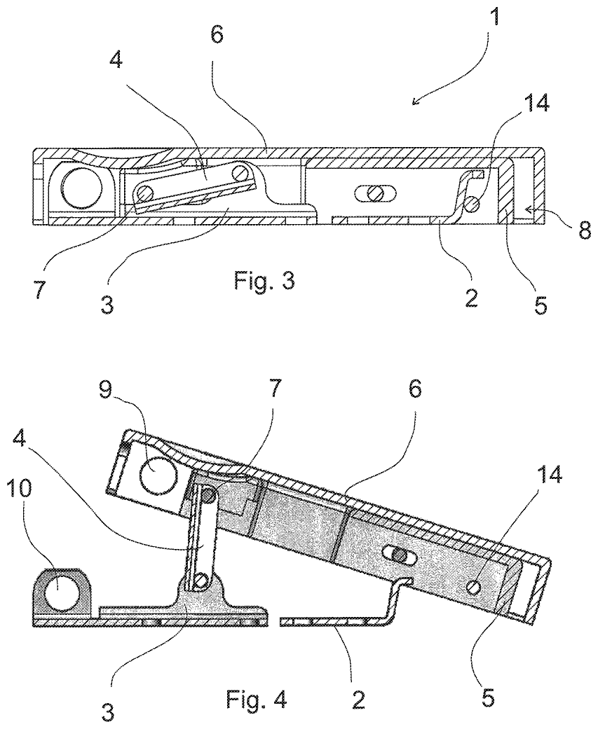

FIG. 3 shows a cross section of the draw latch in the latched position and FIG. 4 shows a cross section of the draw latch in the open position. The draw latch comprises a keeper 2, a base 3, a lever 4, a locking member 5 and a metal housing 6. The keeper 2 is arranged to be attached to a first closure member (not shown) and the base 3 to the second closure member. The closure member may be for example door panel, hatch or frame for a door or a window.

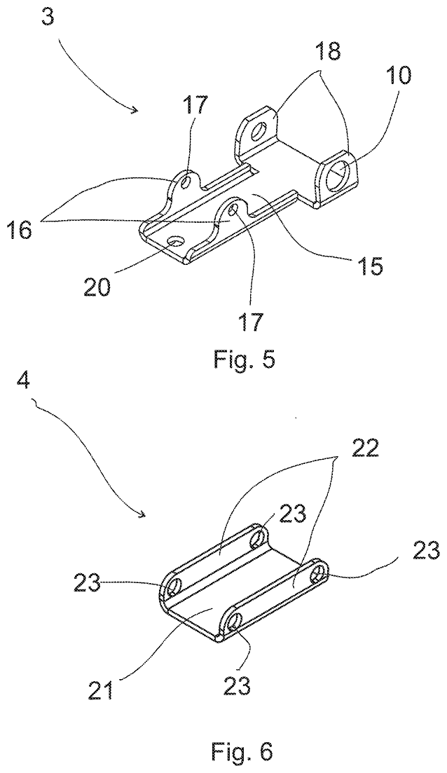

The base 3, as seen in FIG. 5, comprises a bottom wall 15, opposite base side walls 16 and opposite flanges 18, which flanges 18 are parallel to the base side walls 16. And they extend from the bottom wall 15 in the same direction with each other. The base side walls 16 have base apertures 17 arranged to receive a pin or such to facilitate the connection of the base 3 to the lever 4. The base is attached to the second closure member for example by screws or other suitable fasteners. Therefore, the bottom wall 15 may comprise at least one screw hole 20. The flanges 18 may comprise openings 10 arranged to receive locking means.

According to one embodiment, the base 3 is a metal sheet, wherein the base side walls 16 and the flanges 18 are folded from the bottom wall 15.

The lever 4, as seen in FIG. 6, comprises a lever base 21 and opposite side walls 22 extending from the lever base. The longitudinal ends of the side walls 22 have apertures 23 arranged to receive a pins or such to facilitate the connection of the lever 4 to the base 3 and to the locking member 5 in respective ends of the lever 4.

According to one embodiment, the lever 4 is a metal sheet, wherein the side walls 22 are folded from the lever base 21.

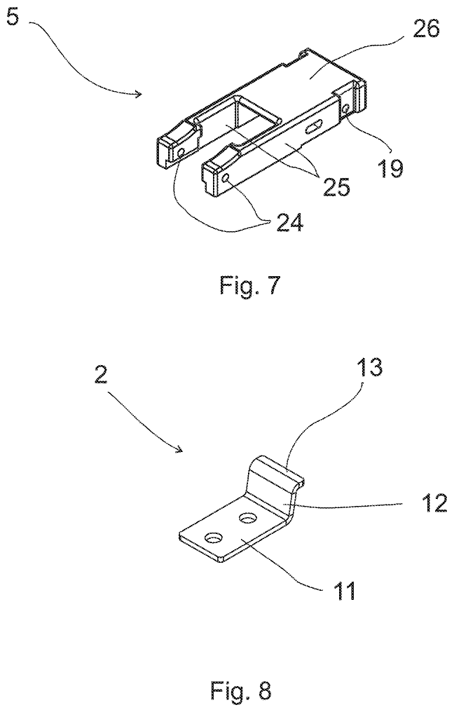

The locking member 5, as seen in FIG. 7, comprises a body wall 26 and opposite locking member side walls 25 extending from the body wall. The locking member side walls 25 comprise first transverse apertures 24 at the first end, which end is arranged to be connected to the lever 4. The first transverse apertures 24 are arranged to receive a pin or such to facilitate the connection of the locking member 5 to the lever 4. At the second end, which end is farther from the lever 4, the locking member side walls 25 comprise second transverse apertures 19, which are arranged to receive a transverse shaft. The locking member 5 is made of elastic material having sufficient stretch and recovery characteristics. Thus, it does not wear in use like hard materials and retains its shape longer. The elasticity also allows relative movement, caused by vibrations and other external forces, between the closure members when the draw latch 1 is in the latched position and the closure members are secured. The elastic locking member also will elongate longitudinally as it partially overlaps the keeper 2 and the draw latch 1 is turned in the latched position.

According to one embodiment, the elastic material is rubber.

The keeper 2, as seen in FIG. 8, comprises a flat portion 11, a middle portion 12 and a protrusion 13. The flat portion 11 is arranged to be attached to the first closure member for example by screws or other suitable fasteners. Therefore, the flat portion may comprise apertures for the screws or such. The middle portion 12 is extending, essentially upwards, from the flat portion 11 and the protrusion 13 extends further from the middle portion 12. The protrusion forms a flange or notch, which detents the locking member when the draw latch is in the latching position.

According to one embodiment, the keeper is a flat sheet and the middle portion 12 is folded from the flat portion 11 to a one direction and the protrusion 13 is further folded from the middle portion 12 to the opposite direction than the folding direction of the middle part 12.

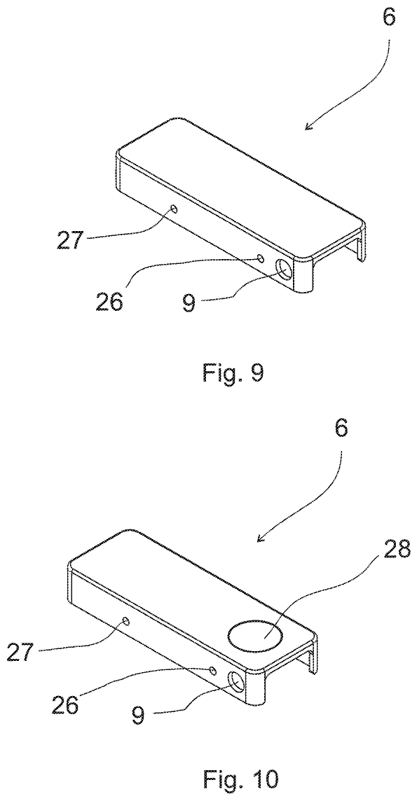

The metal housing 6, as seen in FIG. 9, comprises opposite side walls having housing apertures 26 for receiving a pin or such. The metal housing further comprises transverse shaft apertures 27 on the side walls. The transverse shaft apertures 27 are arranged to receive the transverse shaft of the locking member 5. The housing is made of metal as it provides optimal characteristics for the use in watercrafts as it is durable and holds well in extreme weather conditions (e.g. against heat and humidity). The metal housing 6 may comprise at least one locking hole 9 for receiving a locking means.

According to one embodiment, the metal housing 6 is made of steel.

According to one embodiment, the metal housing 6 is made of aluminium.

FIG. 10 shows an embodiment of the metal housing 6, wherein the metal housing comprises a hole 28, which may be used for turning the draw hatch 1 open and further opening the closure members.

FIGS. 3 and 4 illustrate the situation when the draw latch is attached to the closing members. The base 3 and the keeper 2 are arranged essentially on the same level. The keeper 2 is attached to the first closure member and the base 3 is attached to the second closure member. The lever 4 is provided so that the apertures 23 (see FIG. 6) at the one end of the lever are aligned with the base apertures 17 (see FIG. 5). A pin or such is arranged through aligned apertures 23 and base apertures 17 to provide a pivotal connection between the lever 4 and the base 3.

The locking member 5 is arranged inside the metal housing 6 so that the first transverse apertures 24 (see FIG. 7) of the locking member and the housing apertures 26 of the metal housing are aligned, and the second transverse apertures 25 of the locking member and the transverse shaft apertures 26 of the metal housing are aligned. The locking member 5 and the metal housing 6 are attached together by arranging a pin 7 or such through the aligned first transverse apertures 24 and the housing apertures 26, and arranging a transverse shaft 14 through the second transverse apertures 25 and the transverse shaft apertures 26.

The lever 4 is also pivotally connected to the locking member 5 by the same pin 7. The apertures 23 (see FIG. 6) at the other end of the lever 4 are aligned with the first transverse apertures 24 of the locking member 5 and the housing apertures 26 of the metal housing 6, and the pin 7 is arranged through said apertures to provide a pivotal connection between the lever 4 and the locking member 5 (and the metal housing 6 attached to the locking member).

The closure members are secured by pivoting the lever 4 towards the keeper 2 whereby the locking member 5 partially reaches over the keeper so that the transverse shaft 14 overlaps the keeper. The protrusion 13 of the keeper 2 detains the transverse shaft 14 behind the keeper 2 when the locking member 5 is pushed to the latched position by pivoting the lever 4 away from the keeper 2. As the locking member 5 is made of elastic material, it will elongate in longitudinal direction when the locking member 5 passes the position, when the lever 4 is in horizontal position. The draw latch 1 comprises a gap 8 between a first end of the locking member 5, which is nearer to the keeper 2, and the corresponding end of the metal housing 6 (i.e. at the end of the draw latch which comprises the transverse shaft 14). The gap 8 allows the locking member 5 to stretch in longitudinal direction inside the metal housing 6.

As seen in FIG. 3, in latched position, the connection between the lever 4 and the locking member 5 is closer to the second closure member than the connection point between the lever 4 and the base 3 when the keeper is attached to the first closure member and the base is attached to the second closure member. As the locking member 5 passes the position when the lever 4 is in the horizontal position, the elongated locking member 5 recovers a little but remains some elastic strain. Thus, the draw latch does not open by its own motion but requires some effort to be opened.

According to an embodiment, the metal housing 6 comprises at least one locking hole 9 at the second end of the metal housing, which is nearer to the base 3.

According to an embodiment, the metal housing comprises two locking holes 9 located aligned on the opposite side walls.

As seen in FIG. 3, when the draw latch 1 is in the latched position, the locking holes 9 and the openings 10 of the base are aligned for receiving locking means, such as padlock, for locking the draw latch. When the padlock, or such, is provided through the aligned locking holes 9 and the openings 10 of the base, the draw latch may not be easily opened. It would require great force to break either the padlock or the draw latch 1 having the metal housing 6.

Although the invention has been the described in conjunction with a certain type of device, it should be understood that the invention is not limited to any certain type of device. While the present inventions have been described in connection with a number of exemplary embodiments, and implementations, the present inventions are not so limited, but rather cover various modifications, and equivalent arrangements, which fall within the purview of prospective claims.

1. A draw latch for latching together two closure members of a watercraft, which draw latch have an open position, wherein the two closure members are not latched, and a latched position, wherein the two closure members are secured, comprising:
a keeper arranged to be attached to a first closure member,
a base arranged to be attached to a second closure member,
a lever pivotally connected to the base,
a locking member, made of elastic material, pivotally connected to the lever, and arranged to be affixed to the keeper when the draw latch is in the latched position, wherein
the draw latch further comprises a metal housing arranged to cover the keeper, base, lever and elastic locking member against the two closure members when the keeper is attached to the first closure member, the base is attached to the second closure member and the draw latch is in the latched position.

2. The draw latch according to claim 1, wherein the locking member is connected to the lever by a pin, wherein the locking member is arranged to pivot around the longitudinal axis of the pin.

3. The draw latch according to claim 1, wherein the draw latch comprises a gap between a first end of the locking member, which is nearer to the keeper, and the corresponding end of the metal housing.

4. The draw latch according to claim 1, wherein the connection between the lever and the locking member is closer to the second closure member than the connection point between the lever and the base when the keeper is attached to the first closure member, the base is attached to the second closure member and the draw latch is in the latched position.

5. The draw latch according to claim 1, wherein the metal housing comprises at least one locking hole and the base comprises at least one opening, wherein the locking hole and the opening are
arranged to be aligned when the draw latch is in latched position, and
arranged to receive locking means, such as padlock, for locking the draw latch.

6. The draw latch according to claim 1, wherein the elastic material is rubber.

7. The draw latch according to claim 1, wherein the metal housing is made of aluminium.

8. The draw latch according to claim 1, wherein the metal housing is made of steel.

9. The draw latch according to claim 1, wherein the keeper is a flat sheet comprising a flat portion arranged to be attached to the first closure member, a middle portion, and a protrusion so that the middle portion is folded from the flat portion, and the protrusion is further folded from the middle portion so that the flat portion and the protrusion are essentially parallel, whereby the protrusion is arranged to detent the locking member when the draw latch is in latched position.

10. The draw latch according to claim 1, wherein the locking member comprises a transverse shaft arranged to overlap the keeper to detent the draw latch in latched position.

11. The draw latch according to claim 2, wherein the pin and the transverse shaft are arranged to run through the metal housing and the locking member, whereby the metal housing is connected to the locking member.
